(19) United States
(12) Patent Application Publication
(10) Pub. No.: US 2015/0349897 A1
(43) Pub. Date: Dec. 3, 2015

(54) METHOD AND SYSTEM FOR UE MEASUREMENTS IN SUPPORT OF MIMO OTA

(71) Applicant: ZTE (USA) INC., Richardson, TX (US)

(72) Inventor: Carolyn TAYLOR, Homewood, IL (US)

(73) Assignee: Zet (USA) Inc., Richardson, TX (US)

(21) Appl. No.: 14/654,997

(22) PCT Filed: Dec. 23, 2013
(86) PCT No.: PCT/US2013/077410

§ 371 Date: Jun. 23, 2015

Related U.S. Application Data
(60) Provisional application No. 61/746,463, filed on Dec. 27, 2012.

(51) Int. Cl. H04B 17/10; H04W 24/10; H04B 7/04

(52) U.S. Cl. CPC H04B 17/102; H04B 7/0404; H04W 24/10

(57) ABSTRACT

A method of processing the measurements of the user equipment (UE) antenna pattern for Multiple input Multiple Output (MIMO) Over-the-Air (OTA) testing consistent with the UE performing antenna pattern measurements using radiated test methods subsequent to conducted testing where the measured radiation pattern is then utilized. The method involves antenna pattern measurements which do not take into consideration the impact of radiated interference. For the MIMO OTA method it is necessary to estimate UE self-interference so that it can be accounted for during one phase of the throughput measurement process. A preferred method and a system in a packet switched data transfer system for antenna pattern measurements. A multiple Rx antenna UE is provided. A multiple Rx antenna UE includes a processor configured to promote antenna pattern measurements of a signal strength from a network component to the multiple Rx antenna UE. The signal strength of the advanced technology based network is measured when no user data is being transmitted. The invention deals with at least two different measurements: UE received power and relative phase measurements for multiple Rx antenna UEs.

### FIELD OF THE INVENTION

The present invention relates to a method for processing the measurements of the User Equipment (UE) antenna pattern for Multiple Input Multiple Output (MIMO) Over--the-Air (OTA) testing consistent with the UE performing antenna pattern measurements using radiated test methods subsequent to conducted testing where the measured radiation pattern is then utilized. Specifically, the invention relates to a method for processing antenna pattern measurements.

### BACKGROUND

Devices with wireless communications capabilities, such as mobile telephones, handheld devices, devices embedded in laptop computers, Machine-2-Machine devices (M2M), and similar devices, will be referred to herein as User Equipment (UE).

Wireless communications is continuously evolving. There are many advanced technology equipment being introduced that can provide services that were not possible previously. This advanced technology equipment might include, for example, an Enhanced Node B (eNodeB) rather than a base station or other systems and devices that are more highly evolved than the equivalent equipment in a traditional wireless telecommunications system. Such advanced or next generation equipment may be referred to herein as High Speed Packet Access (HSPA) equipment and long-term evolution (LTE) equipment.

In traditional wireless telecommunications systems, transmission equipment in a base station transmits signals throughout a geographic region and is called a “cell”. For LTE and other advanced equipment, the region in which a UE can gain access to a wireless communications network might be referred to as a different name, for instance called a “hot spot”. The terminology for example “cell” will be used herein to refer to any geographic region in which a UE can gain access to a wireless communications network, regardless of the type of UE and regardless of whether the region is a traditional cell, a region served by LTE equipment such as an eNodeB, or some other region in which wireless communications services are available.

Different UEs might use different types of radio access technology (RAT) to access a wireless communications network. Some UEs, which can be referred to as multi-mode UEs, are capable of communicating using more than one RAT. For example, multi-mode UEs may include UEs that can obtain service from at least one mode of UMTS (Universal Mobile Telecommunications System), and one or more different systems such as GSM (Global System for Mobile Communications) bands or other radio systems. As defined herein, multi-mode UEs may be of any various type of multi-mode UE as defined or provided in 3GPP (3rd Generation Partnership Project), Technical Specification Group (TSG) Terminals, Multi-Mode UE Issues, Categories, Principles and Procedures (3G TR 21.910), which is included herein by reference for all purposes. Some examples of RATs or of network technologies that might use different types of RATs include UTRAN (UTMS Terrestrial Radio Access Network), GSM, GSM EDGE Radio Access Network (GERAN), Wireless Fidelity (WiFi), General Packet Radio Service (GPRS), High-Speed Downlink Packet Access (HSDPA), High Speed Packet Access (HSPA), and long-term evolution (LTE). Other RATs or other network technologies based on these RATs may be familiar to one of skill in the art.

Different UEs may also use different types of MIMO and receiver diversity technology, Some UEs, which can be referred to as MIMO UEs, are capable of communicating using more than one antenna. For example, MIMO UEs may include multiple antenna reception and MIMO receivers in the UE.

UEs with different types of MIMO technology and different types of radio access technology (RAT) to access a wireless telecommunication network can be referred to as MIMO multi-mode UEs.

The use of Multiple Input Multiple Output (MIMO) and receiver diversity in the UE is expected to give large gains in downlink throughput performance; for HSPA and LTE devices. Some technologies, such as spatial multiplexing will be referred herein as Multiple Input Multiple Output (MIMO). Other technologies, such as single spatial layer operation will be referred herein as Single Input Multiple Output (SIMO).

There are already defined test methodologies for MIMO and multiple antenna receivers (such as type I and type 3 in 3GPP technical specification TS 25.101 for HSPA demodulation), but it is clear that the ability to duplicate these gains in the field is highly dependent on the performance of the receive-antenna system.

Therefore, there is a need for a test methodology to be created with the aim of measuring and verifying the radiated performance of multi-antenna and MIM( )receiver in UEs for both HSPA and LTE devices.

Measurement of radiated performance for MIMO and multi-antenna reception for HSPA and LTE terminals must be performed Over-the-Air (OTA), i.e. without RF cable connections to the Device-Under-Test (DUT.)

### SUMMARY OF THE INVENTION

An object of the invention is to provide a method for processing antenna pattern measurements as discussed above.

Hence, in a first aspect there is provided a MIMO multi-mode UE. The MIMO multi-mode UE includes a processor configured to promote measurements of a signal strength in a communication system running an application.

In the second aspect the MIMO multi-mode UE includes a processor configured to promote measurements of a signal strength from a network component to the multiple Rx antenna UE. The signal strength of the advanced technology based network is measured when no user data is being transmitted.

In the third aspect Layer I provides measurement capabilities for the MIMO multi-mode UE and network in order to facilitate the measurement of the UE antenna pattern. The method includes measuring the UE antenna pattern of the received power and relative phase.

In the fourth aspect a method for measuring signal strength is provided. The method includes measuring the UE antenna pattern using wideband measurement bandwidths. The method includes the capability of MIM( )multi-mode UE antenna pattern being measured separately for different parts of the operating bandwidth.

In the fifth aspect a method for measuring signal strength is provided. The method includes measuring the UE antenna pattern using sub-band measurement bandwidths. In the sixth aspect a method for measuring signal strength is provided. The method includes creating a criterion that triggers the UE to send a measurement report. This can either be periodical or a single event description.

In the seventh aspect a procedure for interfacing to the Test Control entity is defined. The method includes a control plane procedure that allows UE antenna pattern measurement request and UE antenna pattern measurement report.

In other words, the method for processing antenna pattern measurements is based on the MIMO multi-mode UE performing antenna pattern measurements using radiated test methods subsequent to conducted testing where the measured radiation pattern is then utilized. The method involves antenna pattern measurements which do not take into consideration the impact of radiated interference. In theory, the method comprises a first step of creating a criterion that triggers the UE to send a measurement report. This can either be periodical or a single event. In order to facilitate the measurement of the UE antenna pattern the UE measurements of received power and relative phase is defined. In the next step it comprises of the measurement of the UE antenna and correlation properties. In the third step it comprises of a control plane procedure that allow efficient use of wireless communication interfaces for conducted MIMO OTA testing. In the fourth step it comprises of performing antenna pattern measurements using radiated test methods followed by conducted testing where the measured radiation pattern is then utilized.

The system consists of a transmitter and receiver for data transfer, a system for testing a radio frequency (RF) Multi-mode UE, the Multi-mode UE having wireless communications capabilities, such as mobile telephones, handheld devices, devices embedded in laptop computers, Machine-2-Machine devices (M2M), and similar devices. UEs with different types of MIMO technology and different types of radio access technology (RAT) to access a wireless communication network. The network equipment might include, for example, an Enhanced Node B (eNodeB) or other systems.

The radiated performance of multi-antenna and MEMO receiver in MEMO multi-mode UEs is measured. Measurement of radiated performance for MIMO and multi-antenna reception UEs suitable for measurements being performed Over-the-Air (OTA), i.e. without RF cable connections to the Device-Under-Test (DUT).

The objectives of the present invention will become apparent upon reading the following description and upon reference to the accompanying drawings.

It is to be understood that the foregoing general description and the following drawings and detailed description are exemplary and explanatory and are intended to provide further explanation of the invention as claimed.

### BRIEF DESCRIPTION OF THE DRAWINGS

Having thus described the invention in general terms, reference is now be made to the accompanying drawings, which are not necessarily drawn to scale. The accompanying drawings are included to provide a further understanding of the invention, and are incorporated in and constitute a part of this specification. The drawings illustrate disclosed embodiments and/or aspects and, together with the description, serve to explain the principles of the invention, the scope of which is determined by the claims.

In the drawings:

FIG. 1 is a block diagram of a wireless communications system according to an embodiment of the disclosure,

FIG. 2 is a diagram of a data transmission according to an embodiment of the disclosure.

FIG. 3 is a diagram of a method for measuring signal strength according to an embodiment of the disclosure.

FIG. 4 is a diagram of a wireless communications system including a user equipment operable for some of the various embodiments of the disclosure.

FIG. 5 is a block diagram of a user equipment operable for some of the various embodiments of the disclosure.

FIG. 6 is a block diagram of the radio interface protocol architecture according to an embodiment of the disclosure.

FIG. 7 is a block diagram of a Over-the-Air (OTA) system according to an embodiment of the disclosure.

FIG. 8 is a control plane procedure that allows efficient use of wireless communication interfaces for conducted MIMO OTA testing.

### DETAILED DESCRIPTION OF THE INVENTION

The present inventions now will be described more fully hereinafter with reference to the accompanying drawings, in which some examples of the embodiments of the inventions are shown. It is to be understood that the figures and descriptions provided herein may have been simplified to illustrate elements that are relevant for a clear understanding of the present invention, while eliminating, for the purpose of clarity, other elements found in typical systems for UE measurements in support of MIMO OTA and methods thereof. Those of ordinary skill in the art may recognize that other elements and/or steps may be desirable and/or necessary to implement the devices, systems, and methods described herein. However, because such elements and steps are well known in the art, and because they do not facilitate a better understanding of the present invention, a discussion of such elements and steps may not be provided herein. The present disclosure is deemed to inherently include all such elements, variations, and modifications to the disclosed elements, systems, and methods that would be known to those of ordinary skill in the pertinent art. Indeed, these disclosed inventions may be embodied in many different forms and should not be construed as limited to the embodiments set forth herein; rather, these embodiments are provided by way of example so that this disclosure will satisfy applicable legal requirements. Like numbers refer to like elements throughout.

In an embodiment, a MIMO multi-mode HE is provided. The MIMO multi-mode UE includes a processor configured to promote measurements of a signal strength from a network component to the MIMO multi-mode UE.

In another embodiment, a method for measuring signal strength is provided. The method includes measuring a signal strength from a network component to the multiple Rx antenna UE when no data is transmitted.

In another embodiment, a method for measuring signal strength is provided. The method includes measuring a signal strength of the UE antenna pattern of the received power and relative phase.

In another embodiment, a method for measuring signal strength is provided. The method includes measuring the UE antenna pattern using wideband measurement bandwidths. The method includes the MIMO multi-mode UE antenna pattern being measured separately for different parts of the operating bandwidth.

In another embodiment, a method for measuring signal strength is provided. The method includes measuring the UE antenna pattern using sub-band measurement bandwidths.

In another embodiment, a method for UE report measurement of UE antenna pattern information. The method includes a criterion that triggers the UE to send a measurement report. This can either be periodical or a single event.

In another embodiment, a procedure for interfacing to the test control entity. The procedure includes a control plane procedure that allows UE antenna pattern measurement request and UE antenna pattern measurement report.

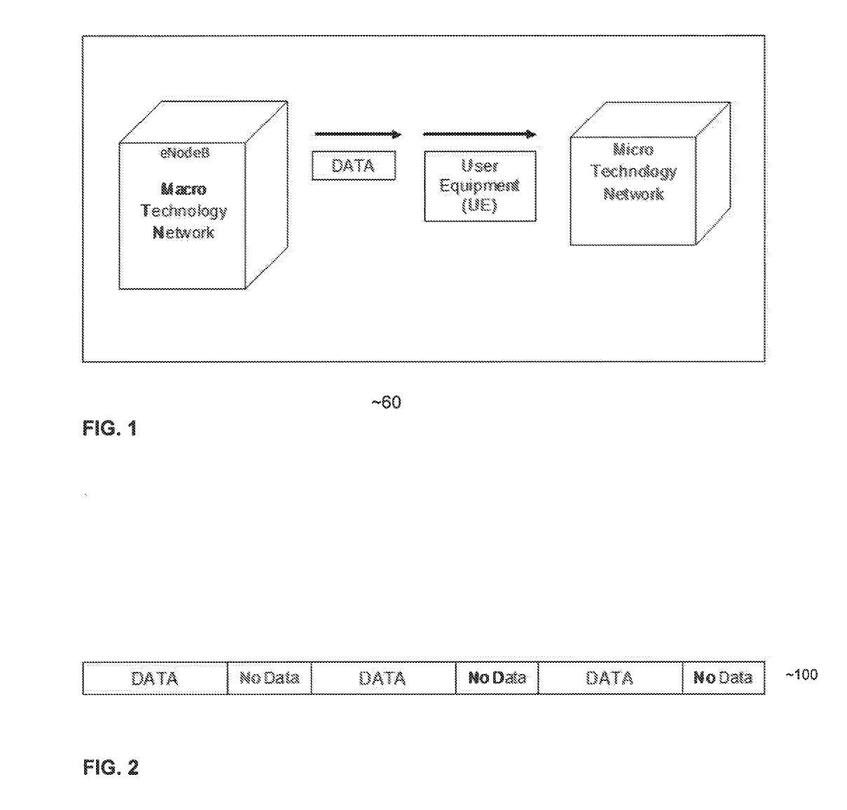

FIG. 1 illustrates a situation in which such a measurement might occur. A UE is moving from a macro technology network toward a micro technology network. The macro technology network includes an eNodeB, or a similar component. The UE may be engaged in a macro technology running an application via the eNodeB. That is, the eNodeB is transmitting data to the UE or is otherwise in communication with the UE.

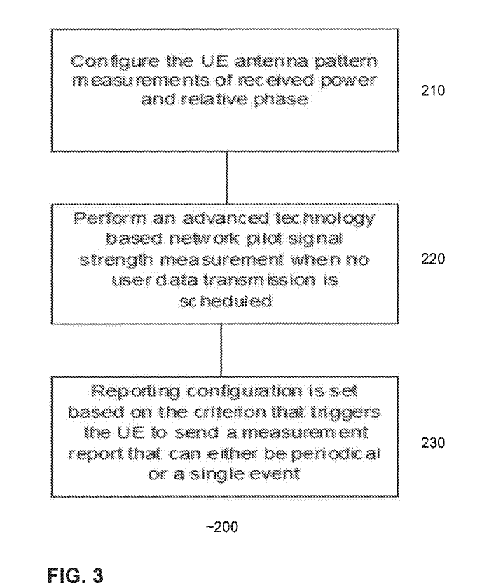

FIG. 2 illustrates a detailed view of the data transmission from the eNodeB to the UE. The data transmission consists of a series data strings separated by transmission period in which no data is transmitted. The data strings might represent some type of a user-directed data transmission. During the period which no data is transmitted, the UE can measure the strengths of the signals that it receives. In a first technique, a method for measuring signal strength is provided. The method includes measuring the UE antenna pattern using wideband measurement bandwidths. The method includes the MIMO multi-mode UE antenna pattern being measured separately for different parts of the operating bandwidth. In an alternative of this technique, a method for measuring signal strength is provided. The method includes measuring the UE antenna pattern using sub-band measurement bandwidths.

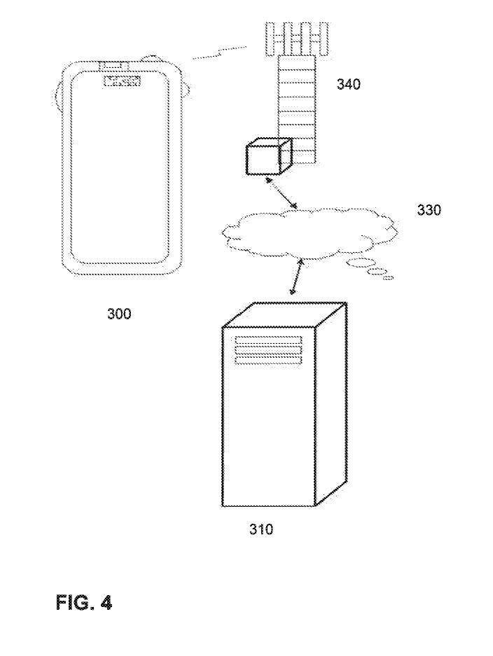

FIG. 3 illustrates an embodiment of a method for measuring the strength of the UE antenna pattern of the received power and relative phase. The measurement of the signal strength is performed when no data is transmitted. The UE send a measurement reporting of UE antenna pattern information.

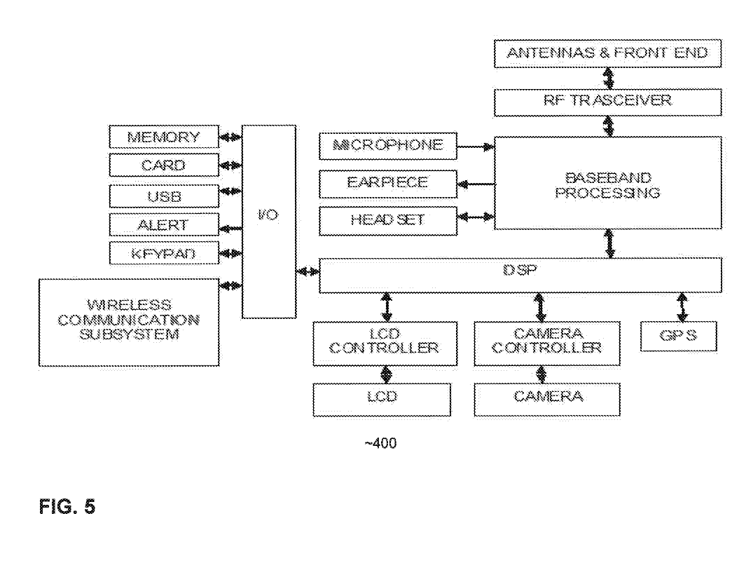

FIG. 4 illustrates a wireless communications system including an embodiment of the MEMO multi-mode UE. Through illustrated as a mobile phone, the UE may take various forms including but not limited to handheld devices, devices embedded in laptop computers, Machine-2-Machine devices (M2M), and similar devices.

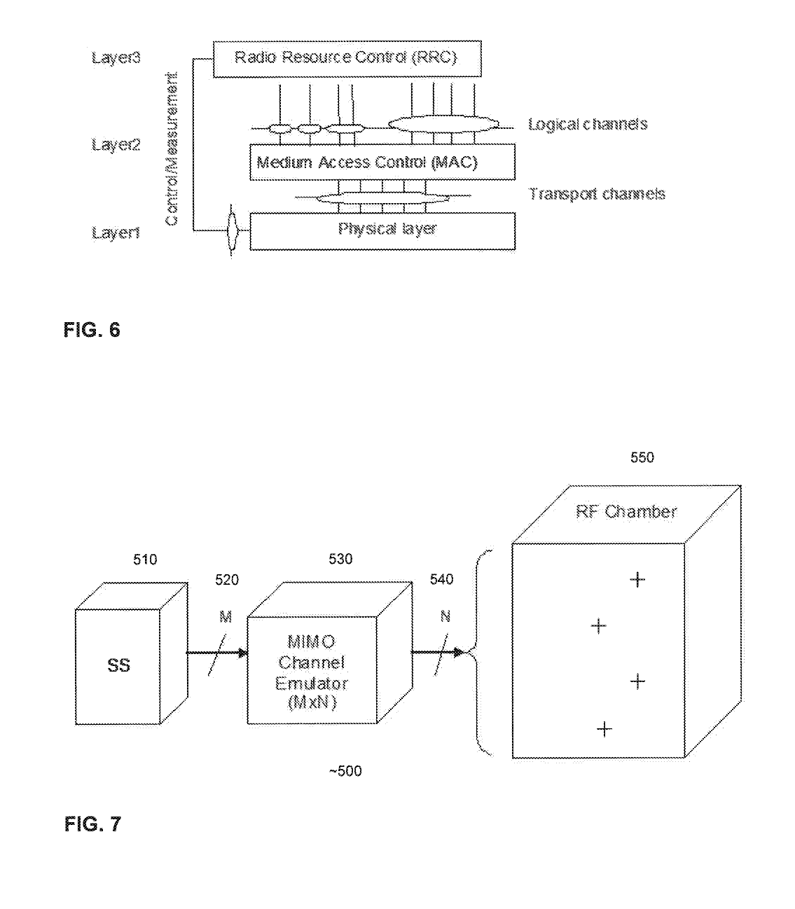

FIG. 5 shows a block diagram of the MIMO multi-mode UE. While a variety of known components of UEs are depicted, in an embodiment a subset of the components and/or additional components not presented may be included in the UE. The UE may use different types of /MIMO and receiver diversity technology. Some UEs, which can be referred to as MIMO UEs, are capable of communicating using more than one antenna. For example, MIMO UEs may include multiple antenna reception and MIMO receivers in the UE.

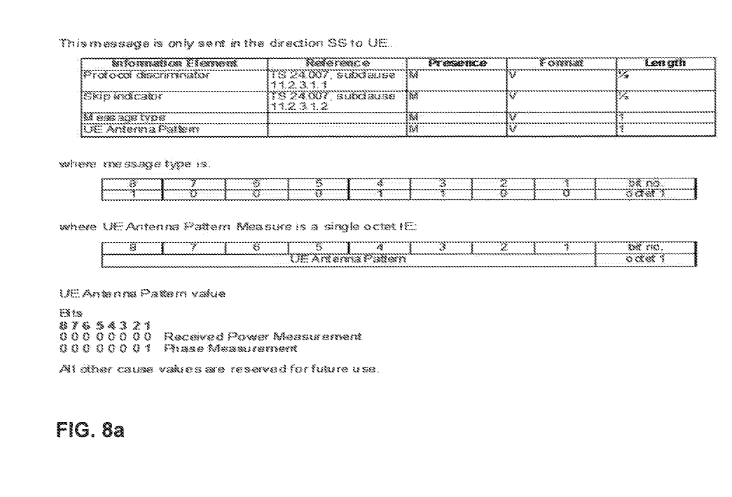

FIG. 6 illustrates communication system radio interface protocol architecture. The interface protocol architecture shows the inference between the UE and the network. It includes Layer 1, 2 and 3.

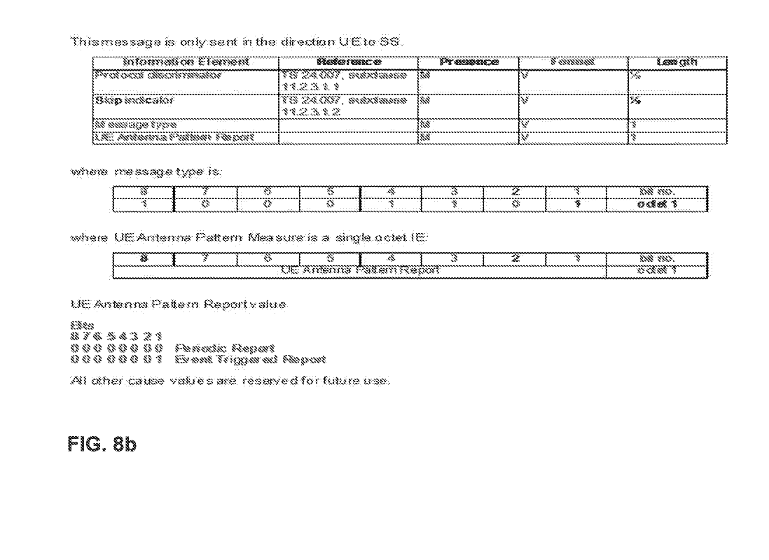

FIG. 7 shows a block diagram of a Over-the-Air (OTA) system. In the embodiment it may include a communication network to generate the M branch MIMO signal, an RF Channel containing N antenna elements with OTA Channel Generation Functionality, and distribute the signal to each probe in the chamber. The system described may be used for testing MIMO performance.

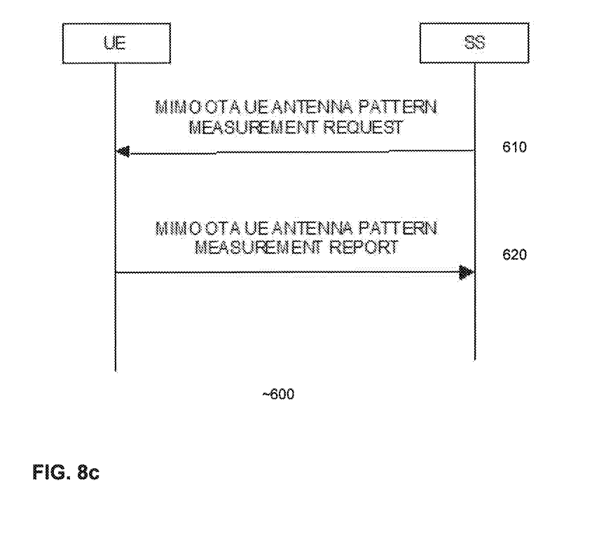

FIG. 8a, 8b, and 8c summarizes the procedure for interfacing to the Test Control entity. The method includes a control plane procedure that allows UE antenna pattern measurement request and UE antenna pattern measurement report.

FIG. 8a illustrates the MIMO OTA UE antenna pattern measurement request. The message is only sent in the direction from network to UE.

FIG. 8b illustrates the MIMO OTA UE antenna pattern measurement report. The message is only sent in the direction of from UE to network,

FIG. 8c illustrates the MIMO OTA UE antenna pattern measurement procedure for testing MIMO performance.

Although specific terms are employed herein, they are used in a generic and descriptive sense only and not for purposes of limitation. Also, the invention has been described and illustrated in exemplary forms with a certain degree of particularity, it is noted that the description and illustrations have been made by way of example only. Numerous changes in the details of construction and combination and arrangement of parts and steps may be made. Accordingly, such changes are intended to be included in the invention, the scope of which is defined by the claims.

What is claimed is:

1. A method for processing measurements of a user equipment (UE) multi-antenna reception pattern, the method comprising:
providing at least one transmitter and at least one receiver for data transfer between at least one network component and the UE, means for measuring signal strength present at the UE's multi-antenna, and at least one processor configured to record at least one measurement of signal strength from the measurement device;
measuring signal strength at the UE's multi-antenna while no user data is being transmitted; and
recording at least one measurement from the at least one measurement device.

2. The method of claim 1, wherein the step of measuring signal strength at the UE's multi-antenna while no user data is being transmitted further comprises measuring the multi-antenna's received power and relative phase.

3. The method of claim 1, wherein the step of measuring signal strength at the UE's multi-antenna while no user data is being transmitted further comprises measuring signal strength for wideband bandwidths.

4. The method of claim 3, wherein the step of measuring signal strength for wideband bandwidths further comprises measuring signal strength separately for at least two different parts of an operating bandwidth.

5. The method of claim 1, wherein the step of measuring signal strength at the UE's multi-antenna while no user data is being transmitted further comprises measuring signal strength for sub-band bandwidths.

6. The method of claim 1, further comprising receiving a measurement request from the at least one network component.

7. The method of claim 1, further comprising transmitting a measurement report to the at least one network component.

8. A method for testing performance of a user equipment (UE) multi-antenna, the method comprising:
providing at least one transmitter and at least one receiver for data transfer between at least one network component and the UE, means for measuring signal strength present at the UE's multi-antenna, and at least one processor configured to record at least one measurement of signal strength from the measurement device;
receiving at least one measurement request from the at least one network component to the UE;
measuring signal strength at the UE's multi-antenna while no user data is being transmitted;
recording at least one measurement from the at least one measurement device; and
transmitting at least one measurement report to the at least one network component.

9. The method of claim 8, wherein the step of measuring signal strength at the UE's multi-antenna while no user data is being transmitted further comprises measuring the multi-antenna's received power and relative phase.

10. The method of claim 8, wherein the step of measuring signal strength at the UE's multi-antenna while no user data is being transmitted further comprises measuring signal strength for wideband bandwidths.

11. The method of claim 10, wherein the step of measuring signal strength for wideband bandwidths further comprises measuring signal strength separately for at least two different parts of an operating bandwidth.

12. The method of claim 8, wherein the step of measuring signal strength at the UE's multi-antenna while no user data is being transmitted further comprises measuring signal strength for sub-band bandwidths.

13. A system for processing measurements of a user equipment (UE) multi-antenna reception pattern, the system comprising:
at least one transmitter and at least one receiver for data transfer between at least one network component and the UE;
means for measuring signal strength present at the UE's multi-antenna while no user data is being transmitted; and
at least one processor configured to record at least one measurement of signal strength from the measurement device.

14. The system of claim 13, wherein the means for measuring signal strength further comprises means for measuring the multi-antenna's received power and relative phase.

15. The system of claim 13, wherein the means for measuring signal strength further comprises means for measuring signal strength for wideband bandwidths.

16. The system of claim 15, wherein the means for measuring signal strength for wideband bandwidths further comprises means for measuring signal strength separately for at least two different parts of an operating bandwidth.

17. The system of claim 13, wherein the means for measuring signal strength further comprises measuring signal strength for sub-band bandwidths.

18. The system of claim 13, further comprising means for receiving a measurement request from the at least one network component.

19. The system of claim 13, further comprising means for transmitting a measurement report to the at least one network component.
